(19) United States
(12) Patent Application Publication
(10) Pub. No.: US 2014/0316920 A1
(43) Pub. Date: Oct. 23, 2014

(54) SYSTEM AND METHOD FOR IMMERSIVE MOBILE GIFTS

(71) Applicant: GiftYa LLC, Pittsburgh, PA (US)

(72) Inventor: Jason WOLFE, Sewickley, PA (US)

(73) Assignee: GiftYa LLC, Pittsburgh, PA (US)

(21) Appl. No.: 14/259,935

(22) Filed: Apr. 23, 2014

Related U.S. Application Data
(63) Continuation-in-part of application No. 14/219,318, filed on Mar. 19, 2014.
(60) Provisional application No. 61/815,103, filed on Apr. 23, 2013.

(51) Int. Cl. G06Q 20/12

(52) U.S. Cl. CPC G06Q 20/12
USPC 705/26.1

(57) ABSTRACT

Disclosed are systems and method related to media and gift credits. A method includes receiving an indication that a giver has given a gift credit to a recipient for use at a merchant. The system then receives a media from the giver, such as an image or a video or other input. Upon confirmation or input from the recipient, the system presents the media on a device of the recipient.

### PRIORITY

This application claims priority to U.S. Provisional Application No. 61/815,103 (Attorney Docket No. 080-0100-CIP-24-Prov), filed 23 Apr. 2013, and to U.S. Non-Provisional application Ser. No. 14/219,318 (Attorney Docket No. 080-0200-CIP), filed 19 Mar. 2014, the contents of each of which are herein incorporated by reference in their entireties.

### BACKGROUND

1. Technical Field

The present disclosure relates to giving gifts and more specifically to enhancing the process of giving and receiving gifts in a more immersive and technology fluent way.

2. Introduction

Gift giving is often connected with social occasions. However, as gift giving and redemption moves into a digital realm, part of the social connections and social aspects of giving a gift are either eliminated or marginalized. This trend can make gift giving seem less personal and less interesting or exciting for the giver and the recipient. Existing electronic delivery approaches for gift delivery and redemption can be inadequate in preserving existing customs, traditions, and expectations for giving or receiving a gift.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Three separate example embodiments are presented herein for enhancing electronic delivery or redemption of gifts to provide a more immersive experience. In the first embodiment, a giver of a gift can use wearable or other ‘intimate’ electronic devices, such as smart glasses or a watch, to view sample electronic greeting or gift cards. One example of smart glasses includes Google Glass. As the giver views the gift or greeting card, the wearable electronic device can then show the giver a video clip or present some other form of media that the giver wants to be displayed to the recipient when receiving the gift or greeting card. The recipient can then also view the video clip or other media when the gift or greeting card is received, upon satisfying some trigger condition such as a geofence or a specific time of day, upon redemption, etc. In one embodiment, the recipient's wearable electronic device can automatically present the video or other media to the recipient, or a server can push the content to the recipient's wearable electronic device.

In a second embodiment, when a recipient of an electronic gift uses his or her wearable electronic device to view the product for which the electronic gift was intended, the wearable electronic device can play a message for the recipient. For example, the giver buys the recipient an electronic gift for a watch that is redeemable when the recipient simply purchases the watch via an associated recipient payment account. Once the recipient views the watch, enters the watch aisle at the store, views an advertisement for the watch, or encounters some other trigger associated with the watch, as detected by the wearable electronic device or an associated sensor or input signal, the wearable electronic device can display to the recipient a video clip or other media from the giver. The video or other media can be a recording of the giver or can be selected from a set of already recorded messages, for example.

In a third embodiment, when a recipient of an electronic gift enters the location of a merchant where the electronic gift is redeemable, a wearable electronic device can detect the location of the recipient. Based on the location coinciding with the merchant, the wearable electronic device can then play a media clip for the recipient from the giver. For example, the giver buys the recipient an electronic gift for the spa. The gift system associates the recipient and the recipient's payment account with the electronic gift. Then, once the recipient enters the spa, the wearable electronic device, such as smart glasses, can initiate a video clip that is attached to the electronic gift that the giver created.

These same concepts can be adapted for other electronic devices besides smart glasses, such as smart phones, watches, implanted devices, and so forth. This approach can provide an augmented reality environment surrounding, supporting, describing, and notifying the recipient of details of the electronic gift.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example embodiment of smart glasses as part of an immersive gift environment;

FIGS. 2A, 2B, 2C, and 2D illustrate example embodiments of smart glasses as part of an immersive gift environment;

FIG. 3 illustrates a method embodiment;

FIG. 4 illustrates another method embodiment;

FIG. 5 illustrates yet another method embodiment; and

FIG. 6 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

In the examples set forth herein, a giver Geoff gives a gift to a recipient Roy. While the various examples are discussed in terms of a single giver, Geoff, and a single recipient, Roy, other variations can include one or more givers and/or one or more recipients. Geoff wishes to give a gift to Roy of a fishing pole or rod up to $250.00. Geoff sets up a policy for a gift to Roy, so that Roy can then use the gift by simply purchasing a qualifying item according to the policy using his existing payment account, such as PayPal, Visa, or American Express account. When a qualifying purchase according to the policy is detected, the gift amount is applied to the purchase, whether at the merchant point of sale, at the financial transaction network, at the bank or payment account institution, or at some other point.

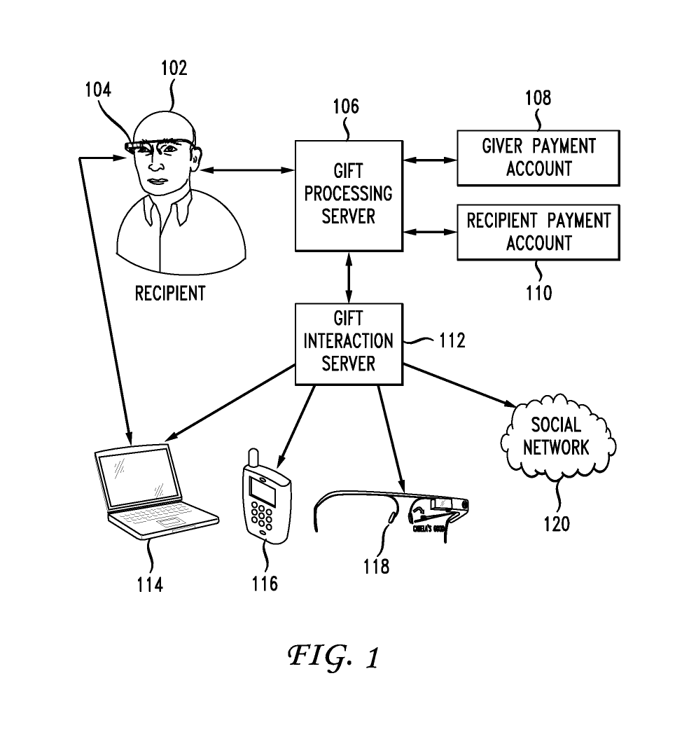

Three separate example embodiments are presented herein for enhancing electronic delivery or redemption of gifts to provide a more immersive experience. These examples are discussed herein in terms of the example smart glasses illustrated in FIG. 1 as part of an immersive gift environment 100.

In this example, a recipient 102 has a wearable electronic device 104 or other ‘intimate’ electronic devices, such as smart glasses, Google Glass, clothing with ‘smart’ components, or a watch. The recipient receives an electronic gift from a giver through a gift processing server 106. The gift is governed by a policy that monitors transactions of the recipient payment account 110 for a qualifying transaction, and applies funds to the qualifying transaction from the giver payment account 108. This arrangement can be modified to include various other steps or possible ways of applying funds from the giver payment account to the recipient payment account for the gift. These same concepts can be adapted for other electronic devices besides smart glasses, such as smart phones, watches, electronic devices embedded in clothing, headsets, electronic pins or jewelry, implanted devices, and so forth. This approach can provide an augmented reality environment surrounding, supporting, describing, and notifying the recipient 102 of details of the electronic gift.

In the first embodiment, a giver of a gift can use the wearable electronic device 118 or some other device 114, 116 to view sample electronic greeting or gift cards. As the giver views the gift or greeting card, the wearable electronic device 104 can then show the giver a video clip or present some other form of media that the giver wants to be displayed to the recipient 102 when receiving the gift or greeting card. This information can be sent to the gift interaction server 112, which governs when and how to deliver the video or other media to the recipient 102. The recipient 102 can then also view the video clip or other media when the gift or greeting card is received, upon satisfying some trigger condition such as a geofence or a specific time of day, upon redemption, etc. In one embodiment, the recipient's 102 wearable electronic device 104 can automatically present the video or other media to the recipient 102, or a server can push the content to the recipient's 102 wearable electronic device 104. In one example, the gift interaction server 112 can coordinate with multiple different recipient devices for a coordinated presentation, such as sending audio to a smart phone and corresponding video to smart glasses.

In a second embodiment, when a recipient 102 of an electronic gift uses his or her wearable electronic device 104 to view the product associated with the policy governing the electronic gift, the wearable electronic device 104 can play a message for the recipient 102 either by itself or according to instructions received from the gift interaction server 112. For example, the giver buys the recipient 102 an electronic gift for a watch that is redeemable when the recipient 102 simply purchases the watch via an associated recipient payment account 110. The wearable electronic device 104 can store the message and conditions for triggering the message. Then, as the wearable electronic device 104 monitors its various sensors and inputs, if the conditions are satisfied the wearable electronic device 104 can present the message to the recipient without receiving any additional instructions, and can even present the message when no network connection is available. Once the recipient 102 views the watch, enters the watch aisle at the store, views an advertisement for the watch, or encounters some other trigger associated with the watch, as detected by the wearable electronic device 104 or an associated sensor or input signal, the wearable electronic device 104 can display to the recipient 102 a video clip or other media from the giver. The video or other media can be a recording of the giver or can be selected from a set of already recorded messages, for example.

In a third embodiment, when a recipient 102 of an electronic gift enters the location of a merchant according to the policy governing the electronic gift, a wearable electronic device 104 can detect the location of the recipient 102. Based on the location coinciding with the merchant, the wearable electronic device 104 can then play a media clip for the recipient 102 from the giver. For example, the giver buys the recipient 102 an electronic gift for the spa. The gift system associates the recipient 102 and the recipient's 102 payment account with the electronic gift. Then, once the recipient 102 enters the spa, the wearable electronic device 104, such as smart glasses, can initiate a video clip that is attached to the electronic gift that the giver created.

These same concepts can be adapted for other electronic devices besides smart glasses, such as smart phones, watches, implanted devices, and so forth. This approach can provide an augmented reality environment surrounding, supporting, describing, and notifying the recipient 102 of details of the electronic gift.

In one variation, instead of or in addition to triggering delivery of a video or other media, triggering a certain condition associated with the gift can initiate some other activity, such as starting a video recording on smart glasses. For example, if the recipient 102 enters the watch aisle at the store, thereby activating a trigger, the recipient's 102 Google Glass can automatically begin recording video of when the recipient 102 first sees the watch, and his or her reaction thereto, the decision process, and so forth. This video can be recorded and saved for later viewing, or can be immediately broadcast to devices 114, 116, 118 of the giver or other parties designated by the giver or the recipient 102. In one example, the recipient can agree to submit the video to the watch manufacturer, the merchant, or the electronic gift processing entity via the gift interaction server 112 for use in promotional or advertising purposes in exchange for a larger gift amount or as part of an entry into a contest. The video of the moments leading up to the purchase can be edited by the recipient 102 prior to broadcasting or posting the video for others to see on a website or social network.

Returning to the example of Geoff giving a gift to Roy, various example method embodiments and sample user interfaces are presented herein for enhancing electronic delivery or redemption of gifts to provide a more immersive, connected, and social experience. While the examples discussed herein refer to the example smart glasses illustrated in FIG. 1 as part of an immersive gift environment 100, other types of devices can be substituted for or used in combination with smart glasses.

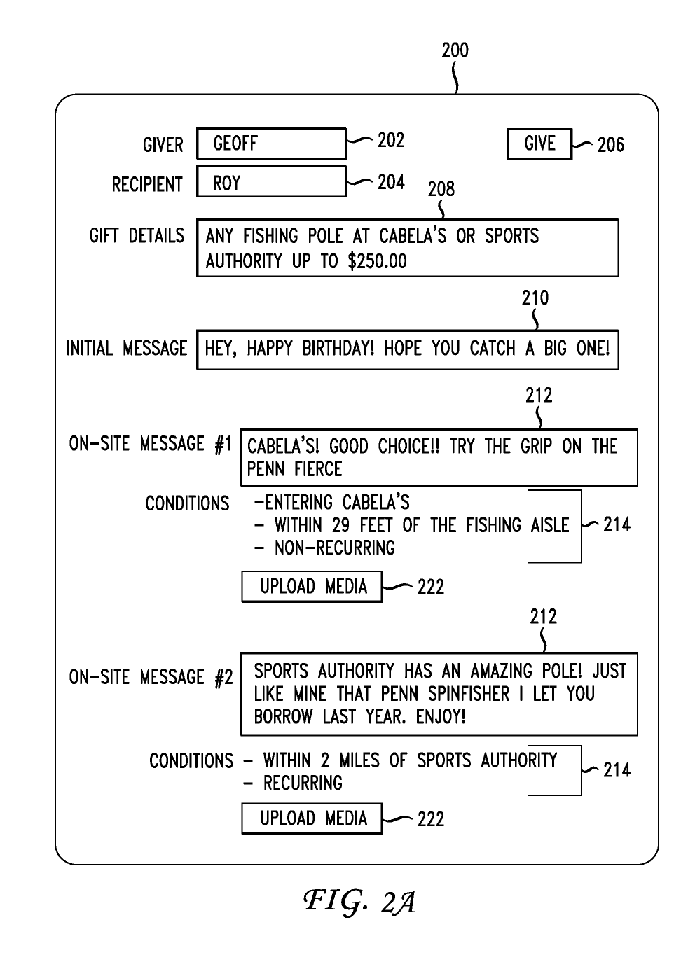

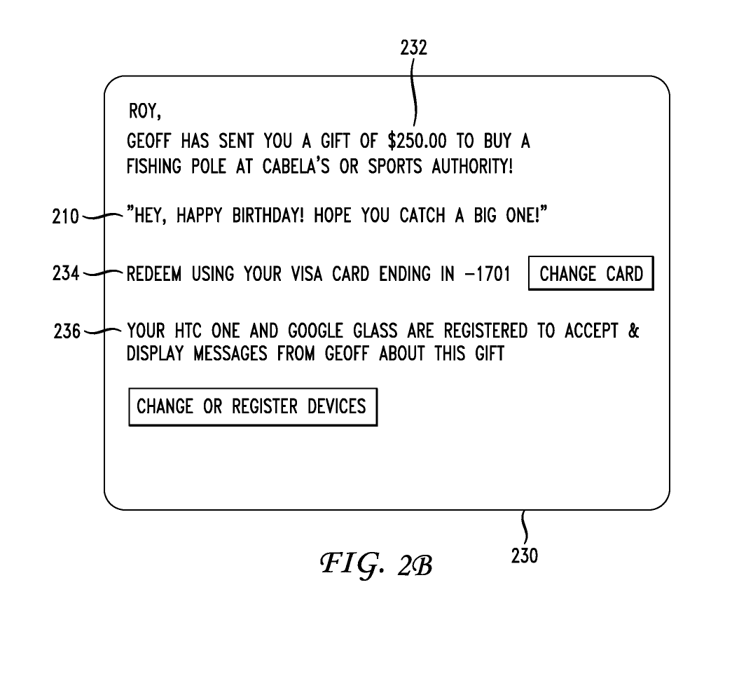

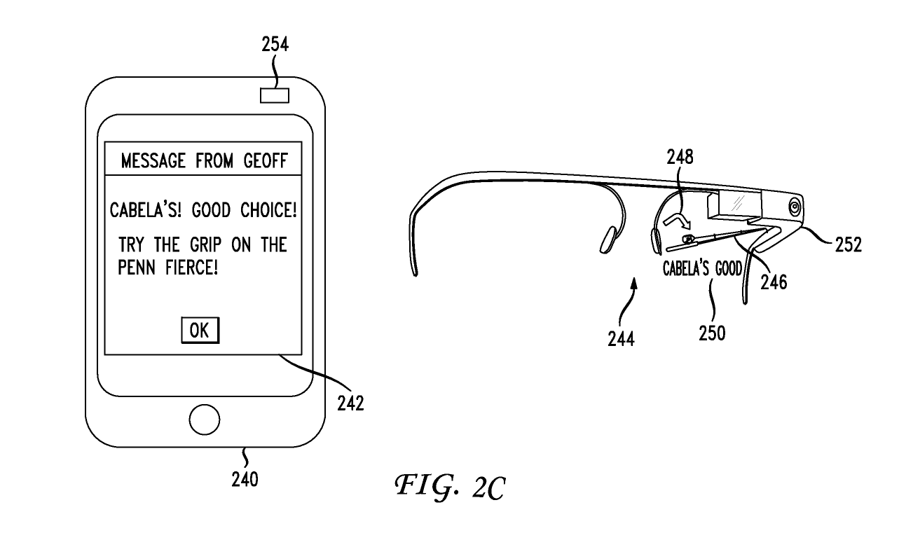

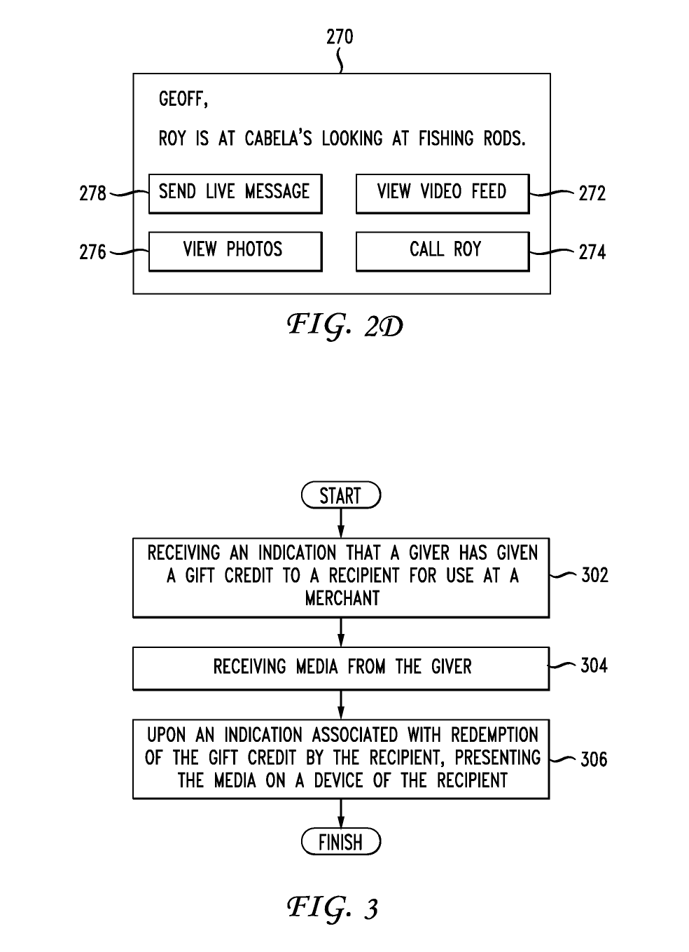

Geoff creates the gift via an example giver user interface 200 as shown in FIG. 2A. The giver user interface 200 can be part of a web page, a mobile app, a spoken dialog system, or other interface. In this example user interface 200, Geoff can fill out his name 202 or the gift processing server 106 can automatically populate that name for display on the user interface 200 or not. Geoff can enter the name of the recipient in the appropriate field 204, or can select the recipient from a list, as well as details 208 about the gift. In this case, the gift details indicate that the gift is applicable to “any fishing pole at Cabela's or Sports Authority up to $250.00.” Geoff can continue to enter additional information, as well as various social or location based interactions to present to Roy and/or Geoff or other parties, such as family members, or other contributors to the gift. Geoff can enter an initial message 210 to Roy, which the system delivers to Roy as part of the notification that the gift has been created or that it is eligible to be used. In this case, the initial message is “Hey, Happy Birthday! Hope you catch a big one!” When Geoff is satisfied with the settings and messages for the gift, he can click the give button 206.

Further, Geoff can set up one or more conditional messages 212. Delivery of such conditional messages can be triggered by satisfying conditions 214 based on certain criteria, such as timing, location, a series of events, an order of events, speed, temperature, humidity, or virtually any other quantifiable input. The criteria can be measured via sensors contained in a device such as a smartphone or a tablet or can be based on information received from a remote sensor or from a network. When the one or more conditions are satisfied, the system can deliver the corresponding message as well as media 222, which can include photographs, audio, video, applications, device settings, or other instructions for controlling at least part of the recipient's device or devices. In this case, the first conditional message 212, which is triggered by the conditions of (1) entering Cabela's, (2) being within 29 feet of the fishing aisle, is the text “Cabela's! Good choice!! Try the grip on the Penn Fierce.” Thus, when the system detects that Roy has met those two conditions, the system delivers the conditional message 212 to Roy, including the text and any media, such as a video or audio message uploaded by Geoff, generated according to instructions from Geoff, or otherwise selected by Geoff. This conditional message is indicated as being non-recurring, meaning that once the conditions are satisfied or the message is successfully delivered to Roy, the system stops monitoring for the conditions.

The second conditional message 212, which is triggered by the conditions of (1) being within 2 miles of a Sports Authority location, is the text “Sports Authority has an amazing pole! Just like mine, that Penn Spinfisher I let you borrow last year. Enjoy!” Thus, when the system detects that Roy has met this condition, the system delivers the conditional message 212 to Roy, including any corresponding text or any other media, such as a video or audio message uploaded by Geoff, generated according to instructions from Geoff, or otherwise selected by Geoff. This conditional message is indicated as being recurring, meaning that the conditions may be satisfied multiple times and the message can be delivered to Roy multiple times, until the gift has been completed, or in other words when Roy has made a purchase that satisfies the conditions or policy associated with the gift.

In other variations, conditional messages 212 can be based on conditions that occur at the point of sale, after the sale, in conjunction with other conditional messages, or virtually any other single condition or trigger or combination of conditions or triggers. For example, one conditional message can be based on a qualifying purchase under a gift policy, and can include variables based on details of the purchase.

In one embodiment, Geoff can choose whether the system informs Roy of the various conditional messages. For example, if Geoff instructs the system to let Roy know, then the system can provide all or part of the information associated with the conditional message to Roy. The system can inform Roy that a special message from Geoff is waiting for Roy when Roy enters Cabela's near the fishing aisle, and when driving by a Sports Authority. In a further variation, Roy has the option to immediately view the messages or to modify the conditions or delivery methods of the conditional messages when the conditions are satisfied. Roy can also choose permissions associated with the conditional message for the gift, such as sharing or publishing images, audio or video associated with the conditional message, to control or alleviate potential privacy or security concerns.

FIG. 3 illustrates a first example method embodiment for creating a gift. In this example, Geoff can use the wearable electronic device 118 or some other device 114, 116 to view sample electronic greeting or gift cards. As Geoff views the gift or greeting card, the wearable electronic device 104 can then show Geoff a video clip or present some other form of media that Geoff wants to be displayed to the recipient 102 when receiving the gift or greeting card. Geoff can submit this information to the gift interaction server 112, which governs when and how to deliver the video or other media to the recipient 102. The gift interaction server 112 can receive the information as an indication that Geoff has given a gift credit to the recipient for use at a merchant (302), and receive media from the giver (304). The media can include executable instructions for executing on the device of the recipient, such as instructions or settings for launching an app, or instructions for execution on the device without a separate app.

Upon an indication associated with redemption of the gift credit by the recipient, the system can present the media on a device of the recipient (306). The recipient 102 can then also view the video clip or other media when the gift or greeting card is received, upon satisfying some trigger condition such as a geofence or a specific time of day, upon application of the gift amount based on a qualifying transaction under the policy, etc. In one embodiment, the wearable electronic device 104 of the recipient 102 can automatically present the video or other media to the recipient 102, or a server can push the content to the recipient's 102 wearable electronic device 104. In one example, the gift interaction server 112 can coordinate with multiple different recipient devices for a coordinated presentation, such as sending audio to a smart phone and corresponding video to smart glasses.

FIG. 2B illustrates an example recipient user interface for receiving the gift. After Geoff creates the gift using an example interface as shown in FIG. 2A, the system can send a notification 230 of the gift to Roy, as shown in FIG. 2B. The notification can include a description of the gift 232, the initial message 210, and/or a description of the policy 234. Roy can change which card or payment account with which the policy is associated. Further, because this gift and policy have at least one associated additional condition, the notification 230 can include an indication 236 of devices through which the system will attempt to deliver additional messages associated with the conditions. For example, the notification 230 can indicate that the messages are associated with Roy's HTC One® and Google Glass® devices. If Roy does not often wear his Google Glass® while shopping, he can choose to either change the device association with the gift, or can elect to bring the Google Glass® with him while he shops. In one variation, the system has an inventory of available devices that are capable of receiving such messages, and can determine which devices are with Roy when the conditions are satisfied. Then the system can transmit messages to those devices. For example, if a collection of three registered devices are in close proximity to each other when the conditions for the message are satisfied, and a fourth registered device is located 10 miles away and is stationary, the system can transmit the conditional messages to one or more of the three devices in close proximity, and can avoid transmitting to the fourth device.

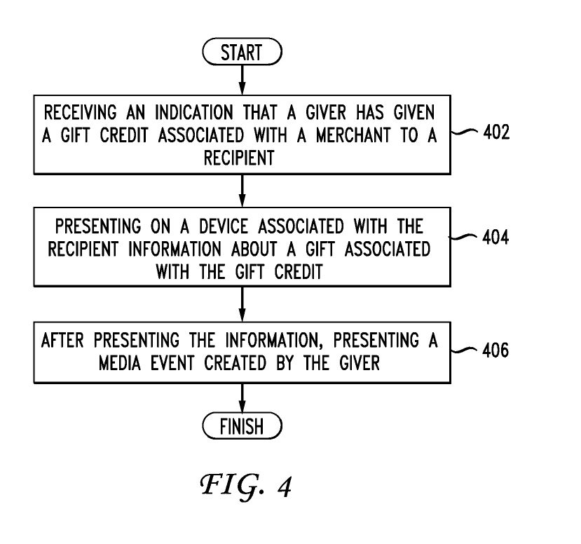

FIG. 4 illustrates a second example method embodiment for notifying a user of a created gift. The system can receive an indication that a giver has given a gift credit associated with a merchant to a recipient (402), and present on a device associated with the recipient information about a gift associated with the gift credit (404). The gift credit can be redeemable by the recipient making a qualifying purchase via a recipient payment account according to a policy associated with the gift credit. The recipient payment account can exist prior to the gift credit.

When a recipient 102 of an electronic gift uses his or her wearable electronic device 104 to view the product associated with the policy governing the electronic gift, the wearable electronic device 104 can play a message for the recipient 102 either by itself or according to instructions received from the gift interaction server 112. For example, the giver buys the recipient 102 an electronic gift for a watch that is redeemable when the recipient 102 simply purchases the watch via an associated recipient payment account 110. The wearable electronic device 104 can store the message and conditions for triggering the message. After presenting the information, the system can present a media event created or selected by the giver (406), such as when the wearable electronic device 104 monitors its various sensors and inputs to determine when the conditions are satisfied. Then the wearable electronic device 104 can present the message to the recipient without receiving any additional instructions, and can even present the message when no network connection is available. Once the recipient 102 views the watch, enters the watch aisle at the store, views an advertisement for the watch, or encounters some other trigger associated with the watch, as detected by the wearable electronic device 104 or an associated sensor or input signal, the wearable electronic device 104 can display to the recipient 102 a video clip or other media from the giver. The video or other media can be a recording of the giver or can be selected from a set of already recorded messages, for example.

The giver can create the media event or select the media event from a set of media events or media event templates based on respective sets of conditions for each of the set of media events. Media events can include at least one of audio, video, text, or executable instructions.

FIG. 2C illustrates an example recipient user interface for redeeming the gift when one of the conditional messages has been triggered. In this example, a telephone 240 and smart glasses 244 are linked to the conditional message, in this case the first conditional message shown in FIG. 2A. When the system detects that the conditions of (1) entering Cabela's and (2) being within 29 feet of the fishing aisle are satisfied, the system can trigger delivery of the conditional message via the telephone 240 and/or the smart glasses 244. For example, the telephone 240 or smart glasses 244 can display a text-based message 242 or other output, such as a video, audio, an image, or illuminate a notification LED 254. The system can trigger certain instructions on the telephone 240 or smart glasses 244, such as launching an app to record or live stream a video feed of Roy selecting his fishing rod at Cabela's. The system can initiate instructions on one device to interact with another device, such as a first app running on the smartphone 240 communicating with an app on the smart glasses 244 in coordination to accomplish a task associated with the conditional message or with the gift purchase.

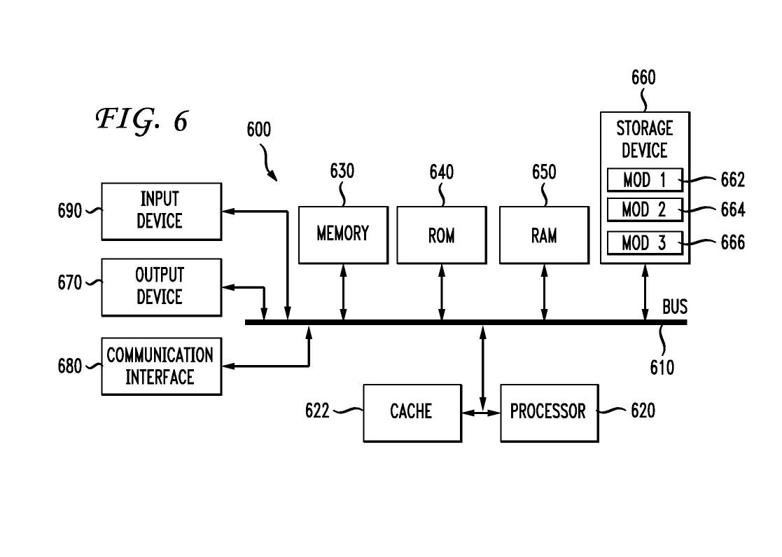

Having disclosed some basic system components and concepts, the disclosure now turns to the exemplary method embodiments. For the sake of clarity, the methods are discussed in terms of an exemplary system 600, as shown in FIG. 6, configured to practice the methods. The steps outlined herein are exemplary and can be implemented in any combination or order thereof, including combinations that exclude, add, or modify certain steps. A first example method embodiment includes receiving an indication that a giver has given a gift credit to a recipient for use at a merchant, receiving a media from the giver, and, upon confirmation from the recipient, presenting the media on a device of the recipient. The device can be part of glasses worn by the recipient. A second example embodiment includes receiving an indication that a giver has given a gift credit associated with a merchant to a recipient, presenting on a device associated with the recipient information about a gift associated with the gift credit, and following the presenting of the information, presenting a media event created by the giver. A third example embodiment includes receiving an indication that a giver has given a recipient a gift credit at a merchant, monitoring a location of a device associated with the recipient, and, when the device is at a merchant location associated with the merchant, presenting a media clip associated with the buyer on the device. The gift credit is an offer, discount, amount of money, or other benefit such as points for use at the merchant, that is linked to the recipient payment account such as a debit, credit or other type of account. The recipient only needs to go and shop using the same basic payment account and the media associated with the gift credits can be applied before or after the purchase according to this disclosure.

FIG. 4 illustrates another method embodiment which includes receiving an indication that a giver has given a gift credit associated with a merchant to a recipient (402), presenting on a device associated with the recipient information about a gift associated with the gift credit (404) and following the presenting of the information, presenting a media event created by the giver (406). An example of this approach is where Mary or a merchant or a bank gives a gift credit of say $5 to Joe that is associated with dinner at Olive Garden. Joe on his smart phone receives an email or a notification or an offer about the discount or gift and following the presentation (or at the same time or in response to a request or input by Joe), the device presents a media event created by the giver, such as a picture or a video or any other media event created by the giver.

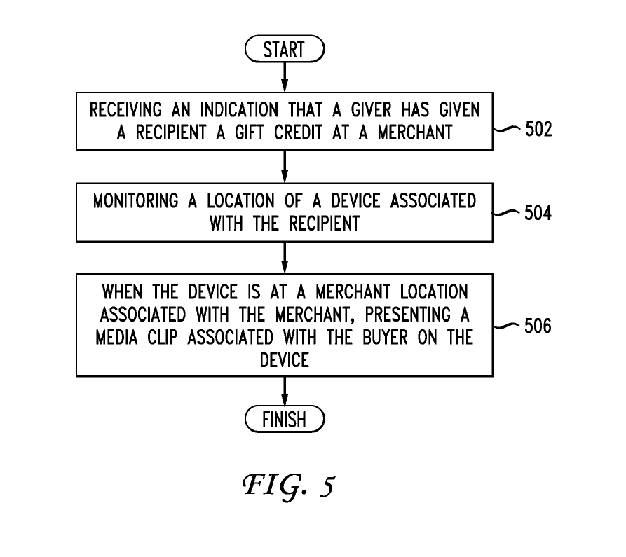

FIG. 5 illustrates yet another method embodiment including receiving an indication that a giver has given a recipient a gift credit at a merchant (502), monitoring a location of a device associated with the recipient (504) and when the device is at a merchant location associated with the merchant, presenting a media clip associated with the buyer on the device (506). An example of this in operation is where the giver (person or business entity) gives a gift credit for use at a merchant to a recipient, and once the data is in the system, the system has a policy or a profile for that gift in which the system monitors the location of a recipient device such as a smart phone or other mobile device. When the device is at a merchant location associated with the gift credit, the system presents a media presentation, such as an image or a video, on the device of the recipient. The giver may have created the device such as a brief video with the giver stating: “Surprise, Happy birthday! Enjoy your dinner at Olive Garden!” A policy or profile can govern the presentation of the media event, such as timing and groupings. For example, the giving entity can record two media events, one for presentation before, and one for presentation after the purchase. The giving device can establish that the first media event can be presented on the device based on geolocation of the device at the merchant. The second media event can be presented after a purchase using the recipient payment account and after the recipient has left the geolocation. Thus, the disclosure enables a tailoring of media events associated with the gift credit in any way desired by the giver. The giving entity could also establish timelines in which the media event (or the second media event) is presented 2 hours after the timing of the purchase using the recipient payment account. The gift credit can be at least one of a gift card, a gift certificate, an electronic gift card, a coupon, or a policy that is redeemable by making a qualifying purchase via a recipient payment account that existed prior to the gift credit, according to the policy associated with the gift credit. When a recipient 102 of an electronic gift enters the location of a merchant according to the policy governing the electronic gift, a wearable electronic device 104 can detect the location of the recipient 102. Based on the location coinciding with the merchant, the wearable electronic device 104 can then play a media clip for the recipient 102 from the giver. For example, the giver buys the recipient 102 an electronic gift for the spa. The gift system associates the recipient 102 and the recipient payment account with the electronic gift. Then, once the recipient 102 enters the spa, the wearable electronic device 104, such as smart glasses, can initiate a video clip associated with the electronic gift that the giver created. Alternatively, the giver can establish a variable or dynamic message or set of actions to perform for the recipient when the conditions are satisfied. For example, the message can vary based on external factors, such as weather, time of day, an RSS feed or other online resource, words recognized in the recipient's speech, which item the recipient has selected, and so forth. The giver can set up various logic constructs via the giver interface 200 to govern delivery details, delivery channel and timing, of conditional messages, as well as any dynamic content for the conditional messages.

When a recipient 102 of an electronic gift enters the location of a merchant according to the policy governing the electronic gift, a wearable electronic device 104 can detect the location of the recipient 102. Based on the location coinciding with the merchant, the wearable electronic device 104 can then play a media clip for the recipient 102 from the giver. For example, the giver buys the recipient 102 an electronic gift for the spa. The gift system associates the recipient 102 and the recipient payment account with the electronic gift. Then, once the recipient 102 enters the spa, the wearable electronic device 104, such as smart glasses, can initiate a video clip associated with the electronic gift that the giver created. Alternatively, the giver can establish a variable or dynamic message or set of actions to perform for the recipient when the conditions are satisfied. For example, the message can vary based on external factors, such as weather, time of day, an RSS feed or other online resource, words recognized in the recipient's speech, which item the recipient has selected, and so forth. The giver can set up various logic constructs via the giver interface 200 to govern delivery details, delivery channel and timing, of conditional messages, as well as any dynamic content for the conditional messages.

FIG. 2D illustrates an example giver user interface with a notification 270 of redemption of the gift. The system can send the notification via an email message, a text message, a notification in a smartphone app, telephone call, or other communication medium. In this notification 270, the system notifies Geoff that Roy is at Cabela's looking at fishing rods. In one embodiment, the notification can only provide information. However, this notification provides several options for interactions, including buttons to send a live message 278, to view a video feed 272, to view photos 276, and to call Roy 274. The text and interaction options of the notification can change based on which conditional message is triggered, based on the recipient's actions, giver preferences, and so forth. Different sets of conditions can trigger delivery of the notification to the giver, Geoff, or to other individuals designated by either Geoff or Roy.

A brief description of a basic general purpose system or computing device in FIG. 6, which can be employed to practice the concepts, is disclosed herein. With reference to FIG. 6, an exemplary system 600 includes a general-purpose computing device 600, including a processing unit (CPU or processor) 620 and a system bus 610 that couples various system components including the system memory 830 such as read only memory (ROM) 640 and random access memory (RAM) 650 to the processor 620. The system 600 can include a cache 622 of high speed memory connected directly with, in close proximity to, or integrated as part of the processor 620. The system 600 copies data from the memory 630 and/or the storage device 660 to the cache 622 for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer readable storage media provide nonvolatile storage of computer readable instructions, data structures, program modules and other data for the computing device 600. In one aspect, a hardware module that performs a particular function includes the software component stored in a non-transitory computer-readable medium in connection with the necessary hardware components, such as the processor 620, bus 610, display 670, and so forth, to carry out the function. The basic components are known to those of skill in the art and appropriate variations are contemplated depending on the type of device, such as whether the device 600 is a small, handheld computing device, a desktop computer, or a computer server.

Although the exemplary embodiment described herein employs the hard disk 660, it should be appreciated by those skilled in the art that other types of computer readable media which can store data that are accessible by a computer, such as magnetic cassettes, flash memory cards, digital versatile disks, cartridges, random access memories (RAMs) 650, read only memory (ROM) 640, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 620. The functions these blocks represent may be provided through the use of either shared or dedicated hardware, including, but not limited to, hardware capable of executing software and hardware, such as a processor 620, that is purpose-built to operate as an equivalent to software executing on a general purpose processor. For example the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 640 for storing software performing the operations discussed below, and random access memory (RAM) 650 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 600 shown in FIG. 6 can practice all or part of the recited methods, can be a part of the recited systems, and/or can operate according to instructions in the recited non-transitory computer-readable storage media. Such logical operations can be implemented as modules configured to control the processor 620 to perform particular functions according to the programming of the module. For example, FIG. 6 illustrates three modules Mod1 662, Mod2 664 and Mod3 666 which are modules configured to control the processor 620. These modules may be stored on the storage device 660 and loaded into RAM 650 or memory 630 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply to any giver. The giver could be a bank, or a merchant, or an advertiser, or any entity. The gift credit is typically an offer that is linked to the recipient payment account. Those skilled in the art will readily recognize various modifications and changes that may be made to the principles described herein without following the example embodiments and applications illustrated and described herein, and without departing from the spirit and scope of the disclosure.

We claim:

1. A method comprising:
receiving an indication that a giver has given a gift credit to a recipient for use at a merchant;
receiving a media from the giver; and
upon confirmation from the recipient, presenting the media on a device of the recipient.

2. The method of claim 1, wherein the device is part of glasses worn by the recipient.

3. A method comprising:
receiving an indication that a giver has given a gift credit associated with a merchant to a recipient;
presenting on a device associated with the recipient information about a gift associated with the gift credit; and
following the presenting of the information, presenting a media event created by the giver.

4. A method comprising:
receiving an indication that a giver has given a recipient a gift credit at a merchant;
monitoring a location of a device associated with the recipient; and
when the device is at a merchant location associated with the merchant, presenting a media clip associated with the buyer on the device.

5. The method of claim 1, wherein the device is part of glasses worn by the recipient.

6. A system comprising:
a processor; and
a non-transitory computer-readable storage device having stored therein instructions which, when executed by the processor, cause the processor to perform operations comprising:
receiving an indication that a giver has given a gift credit to a recipient for use at a merchant;
receiving a media object from the giver; and
upon confirmation from the recipient, presenting the media object on a device of the recipient.

7. The system of claim 6, wherein the device of the recipient comprises a wearable device.

8. The system of claim 6, wherein the media object comprises at least one of an image object, a video object, and an audio object.
